(19) United States
(12) Patent Application Publication
(10) Pub. No.: US 2026/0177443 A1
(43) Pub. Date: Jun. 25, 2026

(54) MICROELECTROMECHANICAL PRESSURE SENSOR

(71) Applicant: Robert Bosch GmbH, Stuttgart (DE)

(72) Inventors: Heribert Weber, Nuertingen (DE); Johannes Classen, Reutlingen (DE); Volkmar Senz, Metzingen (DE); Andreas Scheurle, Leonberg (DE)

(21) Appl. No.: 19/125,455

(22) PCT Filed: Nov. 29, 2023
(86) PCT No.: PCT/EP2023/083510

§ 371 Date: Apr. 29, 2025

(30) Foreign Application Priority Data
Dec. 7, 2022 (DE) 10 2022 213 217.3

(51) Int. Cl. G01L 19/14; G01L 9/00; G01L 19/00; G01L 19/02; G01L 19/06

(52) U.S. Cl. CPC G01L 19/148; G01L 9/0042; G01L 9/0054; G01L 9/0072; G01L 9/0073; G01L 19/0038; G01L 19/02; G01L 19/0618

(57) ABSTRACT

A microelectromechanical pressure sensor. The microelectromechanical pressure sensor includes a substrate and a first pressure sensor arrangement disposed on an upper side of the substrate. The first pressure sensor arrangement includes a first membrane, which is formed by an outer membrane layer of a layer sequence of the first pressure sensor arrangement that faces away from the upper side of the substrate. The substrate and the first membrane enclose a first cavity. The layer sequence includes an inner membrane layer, which is disposed in the first cavity and between the upper side of the substrate and the outer membrane layer. The outer membrane layer is at least partially mechanically and/or electrically connected to at least the inner membrane layer.

### FIELD

The present invention relates to a microelectromechanical pressure sensor.

### BACKGROUND INFORMATION

Certain microelectromechanical pressure sensors comprising a single-layer membrane structure are described in the related art. When using such a single-layer membrane, a pressure sensor can be adapted to a specific pressure range only via the selection of lateral geometric dimensions and/or the selection of a membrane thickness. If the intent is for the pressure sensor to cover a large pressure measuring range, it can be advantageous to use multiple membranes adapted to different pressure ranges on a common substrate in order to achieve precise pressure measurements.

In terms of the process, it is desirable to be able to use the same layer structure for all membranes. This means that all of the membranes have the same membrane thickness and, to adapt to a specific pressure range, the lateral dimensions of the membranes have to be adjusted accordingly. However, this requires that the electrode surfaces of the pressure sensor have to be adjusted accordingly as well. For pressure sensors that are intended to measure higher pressures, this means that a measurement signal is reduced not only by a higher membrane stiffness, but also by the reduction of the electrode surfaces necessitated by the smaller lateral dimensions. The reduction in the useful capacitance between electrode and membrane that accompanies the reduction of the electrode surfaces moreover generally also means that the input stage of the evaluation circuit has to be adjusted, which can entail considerable development costs.

### SUMMARY

An object of the present invention is to provide an improved microelectromechanical pressure sensor. This object may be achieved by a microelectromechanical pressure sensor having certain features of the present invention. Advantageous further developments of the present invention are disclosed herein.

The microelectromechanical pressure sensor of the present invention is based on the idea of realizing a flexibly adjustable membrane stiffness without having to change the lateral dimensions of the membrane of the microelectromechanical pressure sensor, the membrane thickness and the underlying process sequence during the production of the microelectromechanical pressure sensor.

It should also be possible to arrange a plurality of membranes with the same or at least similar lateral dimensions, but different stiffnesses, next to one another in order to cover different pressure measuring ranges, while at the same time, due to the comparable basic capacitance of the two arrangements, using the same evaluation circuit.

According to an example embodiment of the present invention, a microelectromechanical pressure sensor comprises a substrate and a first pressure sensor arrangement disposed on an upper side of the substrate. The first pressure sensor arrangement comprises a first membrane, which is formed by an outer membrane layer of a layer sequence of the first pressure sensor arrangement that faces away from the upper side of the substrate. The substrate and the first membrane enclose a first cavity. The layer sequence comprises an inner membrane layer, which is disposed in the first cavity and between the upper side of the substrate and the outer membrane layer. The outer membrane layer is at least partially mechanically and/or electrically connected to at least the inner membrane layer and/or at least one further layer of the layer sequence.

The microelectromechanical pressure sensor of the present invention is based on the idea that at least two centrically and/or plane-parallel aligned membrane layers, i.e., the inner and the outer membrane layer, are used to form a common double membrane composite. With the same lateral dimensions and when using a mechanically and/or electrically coupled double membrane arrangement, a more or less flexible double membrane structure, which can be deflected more or less from its rest position when pressure is applied, can be achieved by only adjusting the design of the coupling. It is thus possible to create pressure sensors for different measuring ranges, which have an otherwise identical structure and optionally also (almost) identical membrane dimensions and therefore (almost) identical electrode surfaces, simply by adjusting the coupling. The coupling can moreover be influenced by varying the membrane thicknesses of the membrane layers. The coupling between the membrane layers can be realized in two ways.

In one example embodiment of the present invention, the outer membrane layer and the inner membrane layer are connected to one another via first vertical coupling elements that extend between the outer membrane layer and the inner membrane layer, whereby a stiffness of the first membrane can be specified by a number and/or a lateral positioning of the first vertical coupling elements with respect to the first membrane and/or the geometric dimensions of the first vertical coupling elements.

In another example embodiment of the present invention, the inner membrane layer is structured such that it comprises a plurality of separate first portions, whereby a stiffness of the first membrane can be specified by a number and/or a lateral positioning of the first portions of the inner membrane layer with respect to the first membrane and/or the geometric dimensions of the first portions.

Providing a coupled double membrane structure also has the advantage, for instance, that a large pressure range can be covered metrologically with multiple pressure sensors that are produced in parallel (simultaneously) while maintaining high measurement sensitivity. The pressure sensors required for the different pressure ranges can then be produced simply by adjusting the coupling structures or the portions of the inner membrane layer in a uniform manufacturing process.

Therefore, in one example embodiment of the present invention, the microelectromechanical pressure sensor comprises a second pressure sensor arrangement. The first pressure sensor arrangement and the second pressure sensor arrangement are disposed laterally next to one another on the upper side of the substrate and are formed by a common layer sequence. The second pressure sensor arrangement comprises a second membrane. The first membrane and the second membrane are formed by the outer membrane layer. The substrate and the second membrane enclose a second cavity. The inner membrane layer is structured such that the inner membrane layer can be disposed at least partly in the first cavity and at least partly in the second cavity. The outer membrane layer is at least partially mechanically and/or electrically connected to the inner membrane layer such that the first membrane and the second membrane can have different stiffnesses. The first pressure sensor arrangement and the second pressure sensor arrangement can also be used as separate individual components. For this purpose, the pressure sensor arrangements can be singulated after the production of the microelectromechanical pressure sensor.

In one example embodiment of the present invention, the outer membrane layer is connected to the inner membrane layer via first vertical coupling elements disposed in the first cavity and second vertical coupling elements disposed in the second cavity. A number and/or a lateral positioning of the first vertical coupling elements with respect to the first membrane and the second vertical coupling elements with respect to the second membrane and/or the geometric dimensions of the first vertical coupling elements and the second vertical coupling elements can be different.

In one example embodiment of the present invention, the inner membrane layer comprises first portions disposed in the first cavity and second portions disposed in the second cavity. A number and/or a lateral positioning of the first portions with respect to the first membrane and the second portions with respect to the second membrane and/or the geometric dimensions of the first portions and the second portions can be different.

In one example embodiment of the present invention, a first effective electrode is disposed in the first cavity and a second effective electrode is disposed in the second cavity. The first and the second effective electrode are disposed between the upper side of the substrate and the inner membrane layer and are substantially the same size.

It is thus advantageously possible to use the same evaluation circuit for the first and the second pressure sensor arrangements; either one and the same evaluation circuit that is configured to either switch continuously between the pressure sensor arrangements in multiplex mode or switch over permanently in a suitable manner depending on the external pressure being applied, or an evaluation circuit that is duplicated in an ASIC chip, as a result of which the two pressure sensor arrangements can be read in parallel.

In one example embodiment of the present invention, at least one reference electrode is disposed in the first cavity as a reference for the first effective electrode between the upper side of the substrate and the inner membrane layer. The reference electrode can also be provided as a reference for the second effective electrode. The basic idea here is that the reference electrodes of the first pressure sensor arrangement can easily be used in the evaluation of the second pressure sensor arrangement, because the useful capacitances of the first and the second pressure sensor arrangement are comparable if the effective electrodes are substantially the same size. This creates in a particularly high degree of design freedom in the configuration of the stiffening of the second membrane of the second pressure sensor arrangement, because the inner membrane layer is not needed for the implementation of the reference capacitance. Depending on the need, however, it is of course also possible to use subregions of the inner membrane layer or a further layer disposed between the upper side of the substrate and the inner membrane layer in the second pressure sensor arrangement to represent at least one reference electrode.

In another example embodiment of the present invention, a first effective electrode is disposed in the first cavity and a second effective electrode is disposed in the second cavity. The first and the second effective electrode are disposed between the upper side of the substrate and the inner membrane layer. The second effective electrode can be significantly larger than the first effective electrode. In typical applications, one of the pressure sensor arrangements can be operated to measure the barometric pressure, i.e. in a pressure range of a few hundred mbar below and above 1 bar, and is designed and optimized for this pressure range with respect to a signal-to-noise ratio. This would be the first pressure sensor arrangement. Depending on the design, the membrane of a sensor for measuring the barometric pressure can already exhibit considerable predeflection at the typical operating point of 1 bar. The for example substantially stiffer membrane of the second pressure sensor arrangement, on the other hand, can only be deflected very slightly or not at all at the 1 bar operating point. This means that, even if the first and second effective electrodes have substantially the same area, the resulting useful capacitances at the 1 bar operating point for the first and the second pressure sensor arrangement can differ considerably. Consequently, it can be difficult or even impossible to use the same evaluation circuit for both pressure sensor arrangements. To compensate for the different predeflections of the two pressure sensor membranes, the second pressure sensor arrangement comprises a second effective electrode that is significantly larger than the first effective electrode. Appropriately selecting the dimensions of the effective electrodes then makes it possible to ensure that the useful capacitances relevant for the application of the two pressure sensor arrangements and their pressure-dependent change are in a particularly favorable range for the evaluation circuit and for the resulting signal-to-noise ratio, so that the substantially same evaluation circuit can in particular be used again for both pressure sensor arrangements. It also proves particularly advantageous in this embodiment example that it is not absolutely necessary to provide the second pressure sensor arrangement with its own reference electrodes; the reference electrodes from the first pressure sensor arrangement can be used, because the surface area of the second effective electrode can then be selected to be significantly larger than in the first pressure sensor arrangement.

In one example embodiment of the present invention, the layer sequence comprises a further inner membrane layer, which is disposed between the upper side of the substrate and the outer membrane layer. The further inner membrane layer is disposed at least in the first cavity. The further inner membrane layer is at least partially mechanically and/or electrically connected to at least the inner membrane layer and/or at least the outer membrane layer.

The further inner membrane layer advantageously makes it possible to additionally influence the flexibility of the first membrane and thus its pressure-dependent bending via the number, the lateral positioning and/or the geometric dimensions of coupling structures and/or via selected membrane thicknesses of the membrane layers. This configuration makes it possible to avoid geometric adjustments to the lateral membrane dimensions of the first membrane. The selected membrane thicknesses can be the same or different.

In one example embodiment of the present invention, the further inner membrane layer is structured such that the further inner membrane layer is disposed at least partly in the first cavity and at least partly in the second cavity. The further inner membrane layer is at least partially mechanically and/or electrically connected to the inner membrane layer or the inner and the outer membrane layer such that the first membrane and the second membrane have different stiffnesses. The described concept thus offers the advantage that, for example for the production of capacitive pressure sensors for different pressure ranges, in order to be able to produce different flexible membranes, adjustments only have to be made to the design of the coupling structures.

A measurement sensitivity of the microelectromechanical pressure sensor can in principle be further increased by in one embodiment, configuring the first membrane and the second membrane to be operable in a pressure measuring range in a Wheatstone bridge circuit.

The microelectromechanical pressure sensor of the present invention is explained in more detail in the following in conjunction with schematic figures, each example embodiment shown in a cross-sectional view.

### BRIEF DESCRIPTION OF THE DRAWINGS

FIG. 1 shows a microelectromechanical pressure sensor according to a first example embodiment of the present invention.

FIG. 2 shows a microelectromechanical pressure sensor according to a second example embodiment of the present invention.

FIG. 3 shows a microelectromechanical pressure sensor according to a third example embodiment of the present invention.

FIG. 4 shows a microelectromechanical pressure sensor according to a fourth example embodiment of the present invention.

FIG. 5 shows a microelectromechanical pressure sensor according to a fifth example embodiment of the present invention.

### DETAILED DESCRIPTION OF EXAMPLE EMBODIMENTS

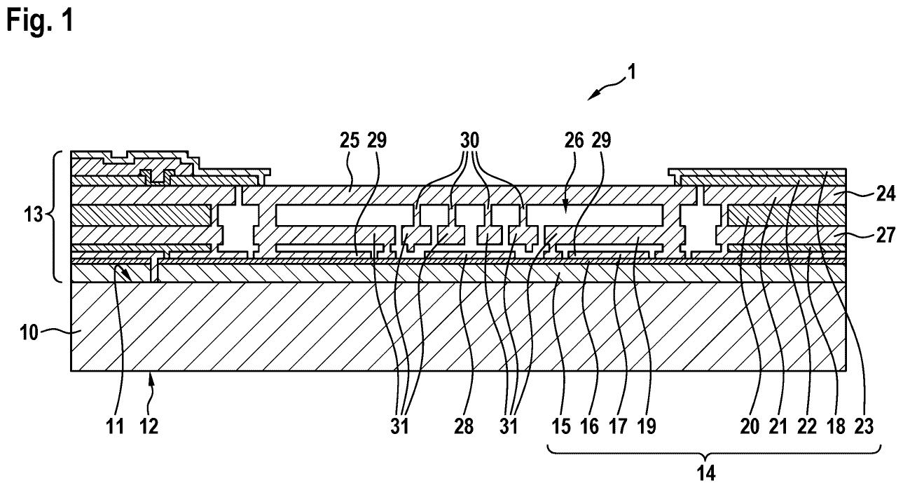

FIG. 1 schematically shows a microelectromechanical pressure sensor 1 according to a first example embodiment of the present invention, hereinafter also referred to briefly as the pressure sensor 1, in a cross-sectional view.

The pressure sensor 1 comprises a substrate 10. The substrate 10 is made of silicon, for example. However, the substrate 10 can also comprise a different material. The substrate 10 comprises an upper side 11 and an underside 12 opposite to the upper side 11. A first pressure sensor device 13 is disposed on the upper side 11 of the substrate 10. The first pressure sensor device 13 comprises a layer sequence 14. The layer sequence 14 is disposed on the upper side 11 of the substrate 10. The layer sequence 14 comprises a plurality of layers disposed successively one above the other. The layers of the example layer sequence 14 are described in the following. However, the number of layers can also differ from the number of layers shown in FIG. 1. Additional functional intermediate layers can be provided as well, for instance.

A first oxide layer 15 of the layer sequence 14 is disposed directly on the upper side of the substrate 10. The first oxide layer 15 comprises silicon dioxide, for example, but can also comprise a different dielectric material. An etch stop layer 16, which can comprise SiRiN (silicon-rich nitride), for instance, or another material suitable for forming an etch stop layer, is disposed directly on a side of the first oxide layer 15 facing away from the substrate 10. The SiRiN layer 16 is provided as an etch stop layer and prevents layers disposed underneath the etch stop layer 16 from being removed during the creation of the first cavity 26. A first electrically conductive layer 17 is disposed directly on a side of the etch stop layer 16 facing away from the first oxide layer 15. The first electrically conductive layer 17 comprises polycrystalline silicon, for example, but can also comprise a different electrically conductive material. A second oxide layer 18 is disposed directly on a side of the first electrically conductive layer 17 facing away from the etch stop layer 16. The second oxide layer 18 comprises silicon dioxide, for example, but can also comprise a different dielectric material. A second electrically conductive layer 19 is disposed directly on a side of the second oxide layer 18 facing away from the first electrically conductive layer 17. The second electrically conductive layer 19 comprises polycrystalline silicon, for example, but can also comprise a different electrically conductive material. A third oxide layer 20 is disposed directly on a side of the second electrically conductive layer 19 facing away from the second oxide layer 18. The third oxide layer 20 comprises silicon dioxide, for example, but can also comprise a different dielectric material. A third electrically conductive layer 21 is disposed directly on a side of the third oxide layer 20 facing away from the second electrically conductive layer 19. The third electrically conductive layer 21 comprises polycrystalline silicon, for example, but can also comprise a different electrically conductive material. A fourth oxide layer 22 is disposed directly on a side of the third electrically conductive layer 21 facing away from the third oxide layer 20. The fourth oxide layer 22 comprises silicon dioxide, for example, but can also comprise a different dielectric material. A passivation layer 23 is disposed directly on a side of the fourth oxide layer facing away from the third electrically conductive layer 21. The passivation layer 23 comprises silicon nitride, for example, but can also comprise a different dielectric material.

The third electrically conductive layer 21 forms an outer membrane layer 24. The layers of the layer sequence 14 are each structured such that the outer membrane layer 24 forms a first membrane 25 and the substrate 10 and the first membrane 25 enclose a first cavity 26 having a first internal cavity pressure. The first membrane 25 is configured to bend depending on the ambient pressure and the prevailing internal cavity pressure. The second electrically conductive layer 19 forms an inner membrane layer 27. The inner membrane layer 27 is disposed at least partly in the first cavity 26. The outer membrane layer 24 is at least partially mechanically and/or electrically connected/coupled to at least the inner membrane layer 27. Coupling the inner membrane layer 27 to the outer membrane layer 24 makes it possible to influence the stiffness of the first membrane 25 without having to change the lateral dimensions of the first membrane 25.

As an example, the outer membrane layer 24 and the inner membrane layer 27 are connected to one another via first vertical coupling elements 30 that extend between the outer membrane layer 24 and the inner membrane layer 27. FIG. 1 shows merely as an example, a total of four first vertical coupling elements 30 are provided, which connect the outer membrane layer 24 to the inner membrane layer 27. However, a different number of first vertical coupling elements 30 can be provided as well. A stiffness of the first membrane 25 can be specified via a number and/or a lateral positioning of the first vertical coupling elements 30 with respect to the first membrane 25 and/or the geometric dimensions of the first vertical coupling elements 30, for instance. FIG. 1 shows as an example that the first vertical coupling elements 30 are disposed in the center of the first membrane 25, but this is not absolutely necessary. A width and/or height of the first vertical coupling elements 30 measured with respect to a direction which extends parallel and/or perpendicular to the upper side 11 of the substrate 10 can be varied in order to vary the stiffness of the first membrane 25.

Also as an example, the inner membrane layer 27 is structured such that it can comprise a plurality of separate first portions 31, which again makes it possible to influence the stiffness of the first membrane 25. First trenches can furthermore be provided between the first portions 31 and separate the first portions 31 from one another. In the shown embodiment, the inner membrane layer 27 comprises six first portions 31, for example, but it can also comprise a different number of first portions 31. A stiffness of the first membrane 25 can be specified by a number and/or a lateral positioning of the first portions 31 of the inner membrane layer 27 with respect to the first membrane 25 and/or the geometric dimensions of the first portions 31. In an alternative embodiment, the coupling between the outer membrane layer 24 and the inner membrane layer 27 can also be achieved via only the first vertical coupling elements 30 without the formation of first portions 31 of the inner membrane layer 27.

The pressure sensor 1 further comprises a first effective electrode 28 and, for example, two reference electrodes 29, which are disposed in the first cavity 26 and on the upper side 11 of the substrate 10. The first effective electrode 28 and the reference electrodes 29 are formed by the first electrically conductive layer 17. At least with a first portion 31 of the inner membrane layer 27 which is coupled to the first membrane 25, the first effective electrode 28 forms a first useful capacitance that depends on a bending of the first membrane 25. The reference electrodes 29 form reference capacitances with a first portion 31 of the inner membrane layer 27 that cannot be changed (by the first membrane 25). The reference capacitances can enable differential capacitance measurements, for instance. The pressure sensor can comprise any number of reference electrodes 29. The reference electrodes 29 can also be omitted.

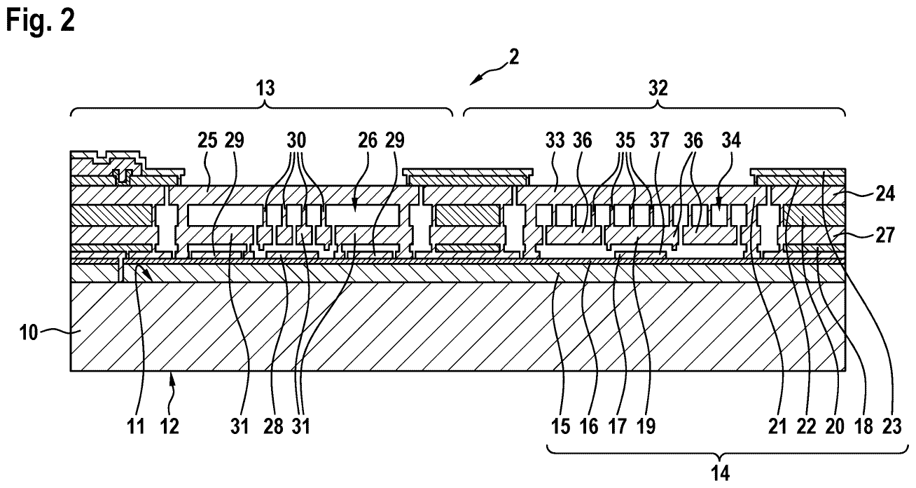

FIG. 2 schematically shows a microelectromechanical pressure sensor 2 according to a second embodiment in a cross-sectional view. The pressure sensor 2 according to the second embodiment has similarities to the pressure sensor 1 according to the first embodiment. Only the differences are discussed in the following description. The reference signs of FIG. 1 are retained for similar or identical elements.

The microelectromechanical pressure sensor 2 according to the second embodiment comprises a second pressure sensor arrangement 32. The first pressure sensor arrangement 13 and the second pressure sensor arrangement 32 are disposed laterally next to one another on the upper side 11 of the substrate 10. The first pressure sensor arrangement 13 and the second pressure sensor arrangement 32 are jointly formed by the layer sequence 14. The second pressure sensor arrangement 32 comprises a second membrane 33. The first membrane 25 and the second membrane 33 are formed by the outer membrane layer 24. The substrate 10 and the second membrane 33 enclose a second cavity 34 having a second internal cavity pressure. The second internal cavity pressure can substantially correspond to the first internal cavity pressure in the first cavity 26. The inner membrane layer 27 is structured such that the inner membrane layer 27 can be disposed at least partly in the first cavity 26 and at least partly in the second cavity 34. The outer membrane layer 24 is at least partially mechanically and/or electrically connected to the inner membrane layer 27 such that the first membrane 25 and the second membrane 33 have different stiffnesses. This allows the first pressure sensor arrangement 13 and the second pressure sensor arrangement 32 to cover different pressure measuring ranges. The lateral dimensions of the first and the second membrane 25, 33 can also be substantially identical or similar in size.

Merely as an example, FIG. 2 shows that the first pressure sensor arrangement 13 is configured according to FIG. 1. In the second pressure sensor arrangement 32, the coupling between the outer membrane layer 24 and the inner membrane layer 27 is achieved via second vertical coupling elements 35 and via the provision of second portions 36 of the inner membrane layer 27, for instance. In contrast to the first vertical coupling elements 30 and the first portions 31, the second vertical coupling elements 35 and the second portions 36 are disposed in the second cavity 34.

A number and/or a lateral positioning of the second vertical coupling elements 35 with respect to the second membrane 33 and/or the geometric dimensions of the second vertical coupling elements 35 are different compared to the first pressure sensor arrangement 13. A number and/or a lateral positioning of the second portions 36 with respect to the second membrane 33 and/or the geometric dimensions of the second portions 36 are likewise different compared to the first pressure sensor arrangement 13. As an example, the second pressure sensor device 32 of the pressure sensor 2 according to the second embodiment comprises ten second vertical coupling elements 35 and three second portions 36, but the numbers can vary. The second vertical coupling elements 35 are disposed evenly distributed throughout the second cavity 34, for example. This overall causes the second membrane 33 to be stiffer than the first membrane 25. In an alternative embodiment, the coupling between the outer membrane layer 24 and the inner membrane layer 27 in the second pressure sensor device 32 can be achieved via only the second vertical coupling elements 35 without the formation of second portions 36 of the inner membrane layer 27.

The second pressure sensor device 32 further comprises a second effective electrode 37 which is disposed in the second cavity 34 and on the upper side 11 of the substrate 10. The first effective electrode 28, the reference electrodes 29 of the first pressure sensor device 13 and the second effective electrode 37 of the second pressure sensor device 33 are jointly formed by the first conductive layer 17 of the layer sequence 14. At least with a portion 36 of the inner membrane layer 27 which is connected to the second membrane 33 via coupling elements 35, the second effective electrode 37 forms a second useful capacitance that depends on a bending of the second membrane 33.

As an example, FIG. 2 shows that the first effective electrode 28 and the second effective electrode 37 are substantially the same size. An advantage of the pressure sensor 2 according to the first embodiment is that, when the first and the second membrane 25, 33 are substantially the same size and when the first effective electrode 28 and the second effective electrode 37 are substantially the same size, different pressure ranges can be covered without having to adjust the lateral dimensions of the membranes 25, 33 or the effective electrodes 28, 37.

In contrast to the first pressure sensor device 13, the second pressure sensor device 32 does not have reference electrodes, for example. Instead, the reference electrodes 29 of the first pressure sensor device 13 can also be provided as a reference for the second effective electrode 37.

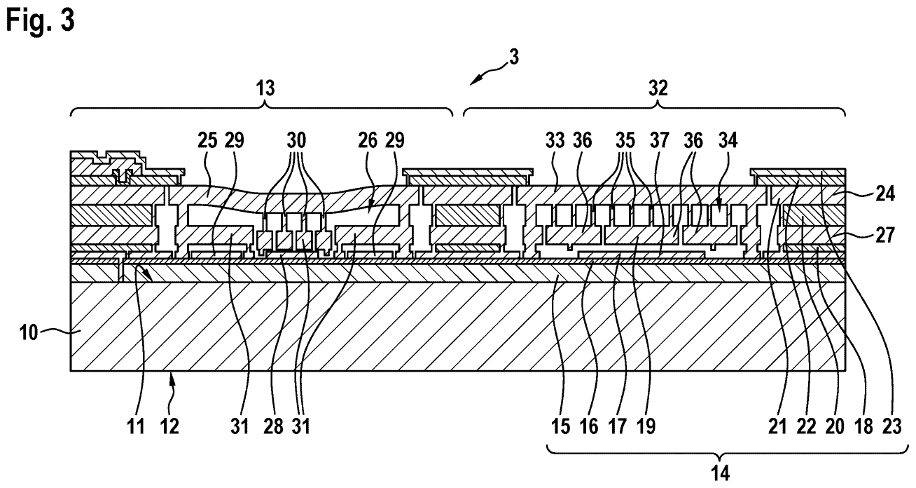

FIG. 3 schematically shows a microelectromechanical pressure sensor 3 according to a third embodiment in a cross-sectional view. The pressure sensor 3 according to the third embodiment has similarities to the pressure sensor 2 according to the second embodiment. Only the differences are discussed in the following description. The reference signs of FIG. 2 are retained for similar or identical elements.

As an example, FIG. 3 shows that the first membrane 25 has a predeflection at one operating point. Since, with respect to the coupling of the inner membrane layer 27 and the outer membrane layer 24, the pressure sensor arrangements 13, 32 of the pressure sensor 3 of the third embodiment are configured in the same way as the pressure sensor arrangements 13, 32 of the pressure sensor 2 according to the second embodiment, the second membrane 33 is stiffer than the first membrane 25 and is therefore not or only slightly deflected or bent compared to the first membrane 25. To compensate for the different predeflections, the second pressure sensor arrangement 32 comprises a second effective electrode 37 that is significantly larger than the first effective electrode 28. This is made possible in particular also by the fact that the second pressure sensor device 32 has no reference electrodes, which is why a large second effective electrode 38 can be provided.

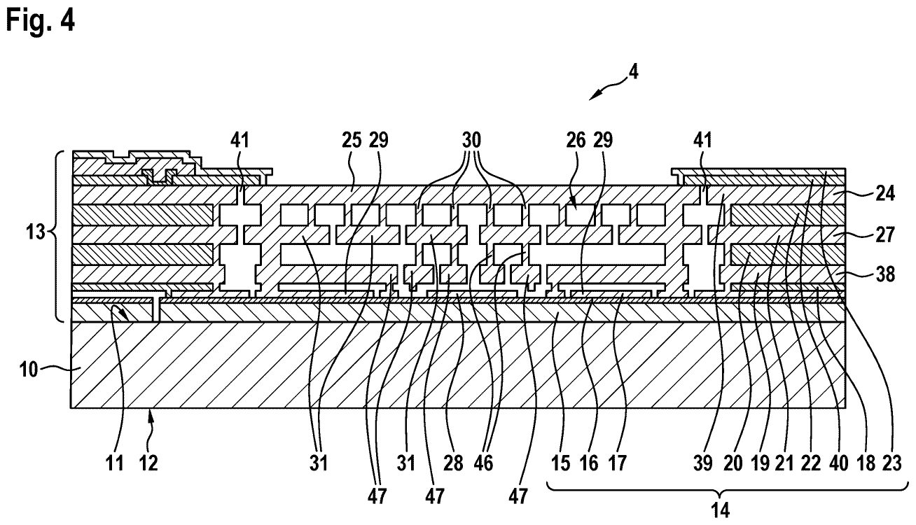

Further embodiments, in which the layer sequence 14 is expanded by disposing additional surface micromechanical layers, are shown in the following. This advantageously creates expanded options for making the stiffness of the membranes 25, 33 flexible. FIG. 4 schematically shows a microelectromechanical pressure sensor 4 according to a fourth embodiment in a cross-sectional view. The pressure sensor 4 according to the fourth embodiment has similarities to the pressure sensor 1 according to the first embodiment. Only the differences are discussed in the following description. The reference signs of FIG. 1 are retained for similar or identical elements. The pressure sensor 4 according to the fourth embodiment comprises only a first pressure sensor device 13, for example, wherein the coupling between the outer membrane layer 24 and the inner membrane layer 27 is configured according to the coupling of the second pressure sensor device 32 of FIG. 2, for instance. However, the pressure sensor 4 according to the fourth embodiment can also comprise a second pressure sensor device 32, as discussed in FIG. 2 or FIG. 3, in which the coupling of the outer and the inner membrane layer 24, 27 is configured differently than the coupling of the first pressure sensor device 13.

The layer sequence 14 comprises a further inner membrane layer 38 disposed between the upper side 11 of the substrate 10 and the outer membrane layer 24. The further inner membrane layer 38 is disposed at least in the first cavity 26. The further inner membrane layer 38 is at least partially mechanically and/or electrically connected to the inner membrane layer 27 or the outer and the inner membrane layer 24, 27. The further inner membrane layer 38 can be produced in a variety of ways. Starting from the arrangement of FIG. 1, for example, further layers can be disposed between the fourth oxide layer 22 and the passivation layer 23.

After the deposition and structuring the fourth oxide layer 22, a fourth electrically conductive layer 39 is disposed on a side of the fourth oxide layer 22 facing away from the third electrically conductive layer 21. A fifth oxide layer 40 is disposed on a side of the fourth electrically conductive layer 39 facing away from the fourth oxide layer 22. In the pressure sensor 4 according to the first embodiment, the outer membrane layer 24 is thus formed by the fourth electrically conductive layer 39. The inner membrane layer 27 is formed by the third electrically conductive layer 21. The further inner membrane layer 38 is formed by the second electrically conductive layer 19 and is disposed between the inner membrane layer 27 and the upper side 11 of the substrate 10.

The further inner membrane layer 38 is connected to the inner membrane layer 27 via further first vertical coupling elements 46 disposed in the first cavity 26. The stiffness of the first membrane 25 can be specified via a number and/or a lateral positioning of the further first vertical coupling elements 46 with respect to the first membrane 25 and/or the geometric dimensions of the further first vertical coupling elements 46. The further inner membrane layer 38 comprises further first portions 47 disposed in the first cavity 26. The stiffness of the first membrane 25 can be specified via a number and/or a lateral positioning of the further first portions 47 with respect to the first membrane 25 and/or the geometric dimensions of the further first portions 47. Merely as an example, FIG. 4 shows that the pressure sensor 4 comprises a total of four further first coupling elements 46 and six further first portions 47. Also as an example, two first portions 31 of the inner membrane layer 27 are respectively connected to two further first portions 47 via two respective further first coupling elements 46.

During the structuring of the third conductive layer 21, the hole structures that penetrate the inner membrane layer 27 can be produced, which are at least partially filled again when the subsequent fourth oxide layer 22 is deposited. With the help of these hole structures, it is possible to remove at least a part of the fourth oxide layer 22 within a later first cavity region in a subsequent HF gas phase etching step. During the structuring of the fourth oxide layer 22, the material of the fourth oxide layer 22 is removed completely at least from the areas needed to anchor the outer membrane layer 24 on the inner membrane layer 27 and from the areas intended to provide mechanical and/or electrical coupling between the outer and the inner membrane layer 24, 27. During the subsequent deposition of the fourth electrically conductive layer 29, the exposed areas in the fourth oxide layer 22 are at least partly filled with a material of the fourth electrically conductive layer 39. After the fourth conductive layer 39 has been deposited, it is structured such that at least one opening 41 is created in the outer membrane layer 24 in which the outer membrane layer 24 is removed completely. The oxide layers 18, 20, 22 in the first cavity region can then be removed completely through the at least one created opening 41 using an HF gas phase etching process. In the described manner, a pressure sensor 4 comprising two inner membrane layers 27, 38 is obtained. The distances between the membrane layers 24, 27, 38 can be selected via the selection of layer thicknesses of oxide layers 18, 20, 22 disposed between the membrane layers 24, 27, 38. The structure described for FIG. 4 also enables stiffening of the first membrane 25 and the implementation of at least one reference electrode 29 and the associated implementation of a reference capacitor structure in the region of the first cavity 26.

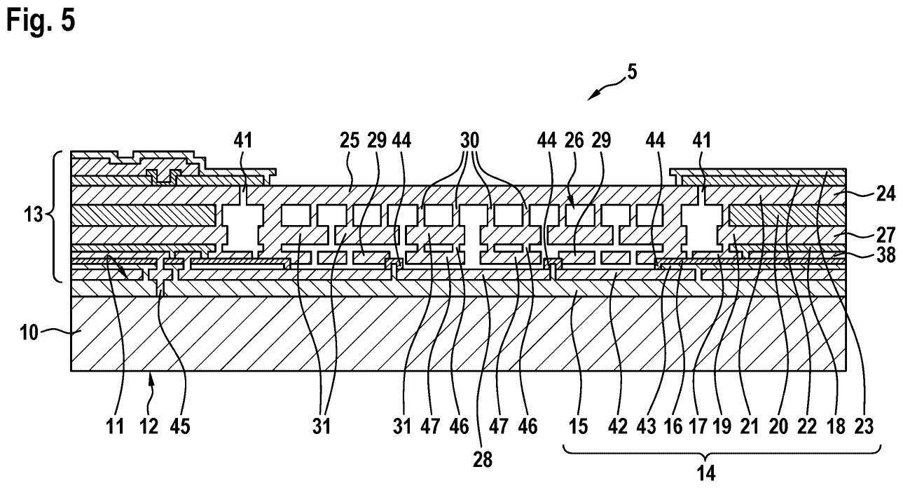

FIG. 5 schematically shows a microelectromechanical pressure sensor 5 according to a fifth embodiment in a cross-sectional view. The pressure sensor 5 according to the fifth embodiment has similarities to the pressure sensor 4 according to the fourth embodiment. Only the differences are discussed in the following description. The reference signs of FIG. 4 are retained for similar or identical elements. The pressure sensor 5 according to the fifth embodiment comprises only a first pressure sensor device 13, for example, wherein the coupling between the outer membrane layer 24 and the inner membrane layer 27 is configured according to the coupling of FIG. 4, for instance. However, the pressure sensor 5 according to the fifth embodiment can also comprise a second pressure sensor device 32, as discussed in FIG. 2 or FIG. 3, in which the coupling of the outer and the inner membrane layer 24, 27 is configured differently than the coupling of the first pressure sensor device 13. FIG. 5 shows an alternative design variant, in which, starting from the arrangement in FIG. 1, the further inner membrane layer 38 is created by providing an additional buried electrical wiring/functional layer between the upper side 11 of the substrate 10 and the etch stop layer 16.

In this variant, starting from the layer structure shown in FIG. 1, a further electrically conductive layer 42 is deposited onto the first, structured oxide layer 15. Areas in which the first oxide layer 15 has optionally been removed completely are at least partially filled with a material of the further electrically conductive layer 42, for example polycrystalline silicon. Since the material of the further conductive layer 42 can also be deposited on the substrate 10, the thus created structures, also referred to as contact hole structures or contact holes 45, can be used for electrically contacting the substrate 10, for example.

The deposited further electrically conductive layer 42 is now structured and can be used to produce a buried electrical wiring/functional layer and to create electrode/reference electrode structures 28, 29. A further oxide layer 43, which can comprise silicon dioxide or another dielectric material, for example, is then deposited on the structured further electrically conductive layer 42. This purpose of this is substantially to be able to set the electrode spacing in later reference capacitor and/or useful capacitor structures. During the deposition of the further oxide layer 43, free areas in the further electrically conductive layer 42 are at least partially filled with the further oxide layer 43. This is followed by the structuring of the further oxide layer 43. The subsequent layer sequences are already shown in FIG. 1. However, adjustments to the layer thicknesses being used can be made for the respective application.

The layer structure now created as in FIG. 1, begins with the deposition of the etch stop layer 16 onto the further oxide layer 43. The etch stop layer 16 at least partially prevents an etching attack on the first oxide layer 15 and the further oxide layer 43 in a later sacrificial layer etching process, e.g. in a HF gas phase etching process. At least partially filling oxide-free areas in the further oxide layer 43 with the material of the etch stop layer 16 also makes it possible to create lateral etch stop structures 44 that are provided at least in the region of the electrodes/reference electrodes 28, 29 and on the electrodes/reference electrodes 28, 29 and with the help of which defined electrode/reference electrode surfaces can be created in a later sacrificial layer etching process.

After the etch stop layer 16 has been deposited, it can be structured such that at least one contact hole 45 through the etch stop layer 16 and the further oxide layer 43 is created and the etch stop layer 16 is removed at least in the regions of the electrodes/reference electrodes 28, 29. Alternatively, it is also possible to remove the etch stop layer 16 and the further oxide layer 43 at least in the region of the electrodes/counter electrodes 28, 29 at the same time as the creation of the contact hole 45, and deposit and structure an additional oxide layer such that, at least in the region of later electrode/reference electrode surfaces, this additional oxide layer is present over the entire surface. This has the advantage that the distance between two later electrodes 28, 29 is dependent only on the deposited layer thickness of the additional oxide layer and is not influenced by a SiRiN etching process.

This is followed by the deposition and structuring of the first electrically conductive layer 17 and the at least partial filling of the contact hole 45. During the structuring of the first electrically conductive layer 17, free areas can optionally be created in the region of electrode/reference electrode surfaces, through which an etching attack on the further oxide layer 43 can take place during a later sacrificial layer etching process. With appropriate design, it can be achieved during the structuring of the first electrically conductive layer 17 that later self-supporting electrode/counter electrode structures consisting of the first electrically conductive layer 17 are at least partially anchored/attached to support structures consisting of the etch stop layer 16 and the further oxide layer 43, which are located at least partially on the further electrically conductive layer 42. This can be used advantageously in the region of later reference capacitor structures in order to be able to ensure a constant electrode spacing here. In the region of the later useful capacitance, on the other hand, the structuring is carried out in such a way that there is no longer a connection between the electrode/counter electrode structure in the first electrically conductive layer 17 and the etch stop layer 16.

After the structuring of the first electrically conductive layer 17, the second oxide layer 18 is deposited and structured. The second oxide layer 18 is removed at least in regions to be used later to anchor the second electrically conductive layer 19 and/or to produce at least one electrical connection between the second electrically conductive layer 19 and the first electrically conductive layer 17. After this, the second electrically conductive layer 19 is deposited and structured. Oxide-free areas in the second oxide layer 18 are filled at least partially with material of the second electrically conductive layer 19.

In the pressure sensor 5 according to the fifth embodiment, in contrast to the pressure sensor 4 according to the fourth embodiment, the outer membrane layer 24 is thus formed by the third electrically conductive layer 21. The inner membrane layer 27 is formed by the second electrically conductive layer 19. The further inner membrane layer 38 is formed by the first electrically conductive layer 17. The further inner membrane layer 38 is at least partially connected to the inner membrane layer 27 via further first vertical coupling elements 46 disposed in the first cavity 26. The stiffness of the first membrane 25 can be additionally influenced by via a number and/or a lateral positioning of the further first vertical coupling elements 46 with respect to the first membrane 25 and/or the geometric dimensions of the further first vertical coupling elements 46. The further inner membrane layer 38 comprises further first portions 47 disposed in the first cavity 26. The stiffness of the first membrane 25 can be additionally influenced via a number and/or a lateral positioning of the further first portions 47 with respect to the first membrane 25 and/or the geometric dimensions of the further first portions 47. Merely as an example, FIG. 5 shows that the pressure sensor 5 comprises a total of four further first coupling elements 46 and eight further first portions 47. Also as an example, two first portions 31 of the inner membrane layer 27 are respectively connected to one further first portion 47 via two respective further first coupling elements 46.

During the structuring of the inner membrane layer 27, the hole structures that penetrate the inner membrane layer 27 can again be produced, which are at least partially filled again when the third oxide layer 20 is deposited. With the help of these hole structures, it is possible to remove at least a part of the further oxide layer 43 within a later first cavity region in a subsequent HF gas phase etching step. During the structuring of the second and the third oxide layer 20, these are removed completely at least from the areas needed to anchor the outer membrane layer 24 on the inner membrane layer 27 and needed to anchor the inner membrane layer 27 on the first electrically conductive layer 17, and from the areas intended to provide mechanical and/or electrical coupling between the membrane layers 24, 27 and 17. During the deposition of the second or the third electrically conductive layer 21, the exposed areas in the second oxide layer 18 or in the third oxide layer 20 are at least partially filled with material of the second electrically conductive layer 19 or with material of the third electrically conductive layer 21. After the outer membrane layer 24 has been deposited, it is structured such that at least one opening 41 is created, in which the outer membrane layer 24 is removed completely. The oxide layers in the first cavity region can then be removed completely through the created at least one opening 41 using an HF gas phase etching process. The at least one opening 41 can then be sealed in a media-tight manner by at least the fourth oxide layer 22 and alternatively by further layers, such as the passivation layer 23.

The internal cavity pressure and the residual gas composition in the at least one cavity 26 depend on the sealing process used to seal the at least one opening 41 in a media-tight manner. To be able to minimize the influence of the internal cavity pressure on the sensor signal or the sensor performance low, it is advantageous to strive for as low an internal cavity pressure as possible. The same internal cavity pressure in a plurality of cavities 26, 34 can be achieved by connecting the cavities to one another via pressure equalization channels (not shown in the figures).

With reference to FIGS. 1 to 5, anchoring structures and/or electrical connection structures between two electrically conductive layers 17, 19, 21, 39, 42 can generally be formed by removing an oxide layer 18, 20, 22, 40, 43 disposed on an electrically conductive layer 17, 19, 21, 39, 42 by means of an etching process in regions used to mechanically anchor and/or electrically connect the subsequently to be deposited electrically conductive layer 17, 19, 21, 39, 42 to or with the electrically conductive layer 17, 19, 21, 39, 42 under the oxide layer 18, 20, 22, 40, 43, and/or to produce at least one lateral etch stop structure which surrounds/delimits a cavity 26, 34.

Compared to the variant of FIG. 4, the variant of the pressure sensor 5 according to FIG. 5 has the advantage that providing a buried electrical wiring/functional layer consisting of the further electrically conductive layer 42 makes it possible to implement a more flexible electrical wiring of the sensor element and also realize a cavity volume of the first cavity 26 that is completely and continuously surrounded by etch stop structures/layers.

A microelectromechanical pressure sensor 1, 2, 3, 4, 5 according to one of the embodiments can be used in connection with smartphones and tablets, wearables, hearables, augmented reality and virtual reality, drones, gaming and toys, robots, smart home, and in an industrial context, among other things for the following applications: HMI (human-machine interface) functionality, e.g. for multi-tap detection, activity, gesture and context detection and user recognition; motion control, gimbal system, altitude and location stabilization, flight control, image stabilization, interior and exterior navigation, floor detection, position tracking and route recording, PDR (pedestrian dead reckoning), dynamic route planning, boundary and obstacle detection, indoor SLAM (simultaneous localization and mapping); intrusion monitoring, real-time motion detection and tracking, activity tracking, calorie counter; logistics, parts tracking, energy management and energy-saving measurement, predictive maintenance; air quality and climate monitoring, mold detection, water level detection; sensor data fusion. A microelectromechanical pressure sensor 1, 2, 3, 4, 5 according to one of the embodiments can moreover be used in connection with automotive applications: crash detection, e.g. in airbag systems; navigation applications; optimization of the engine control and the combustion process in gasoline- or diesel-powered engines.

1-10. (canceled)

11. A microelectromechanical pressure sensor, comprising:
a substrate; and
a first pressure sensor arrangement disposed on an upper side of the substrate, wherein the first pressure sensor arrangement includes a first membrane, which is formed by an outer membrane layer, of a layer sequence of the first pressure sensor arrangement, that faces away from the upper side of the substrate;
wherein the substrate and the first membrane enclose a first cavity,
wherein the layer sequence includes an inner membrane layer, which is disposed in the first cavity and between the upper side of the substrate and the outer membrane layer,
wherein the outer membrane layer is at least partially mechanically and/or electrically connected to at least the inner membrane layer.

12. The microelectromechanical pressure sensor according to claim 11, wherein the outer membrane layer and the inner membrane layer are connected to one another via first vertical coupling elements that extend between the outer membrane layer and the inner membrane layer, whereby a stiffness of the first membrane can be specified by a number and/or a lateral positioning of the first vertical coupling elements with respect to the first membrane and/or geometric dimensions of the first vertical coupling elements.

13. The microelectromechanical pressure sensor according to claim 11, wherein the inner membrane layer is structured such that it includes a plurality of separate first portions, whereby a stiffness of the first membrane can be specified by a number and/or a lateral positioning of the first portions of the inner membrane layer with respect to the first membrane and/or the geometric dimensions of the first portions.

14. The microelectromechanical pressure sensor according to claim 11, further comprising:
a second pressure sensor arrangement, wherein the first pressure sensor arrangement and the second pressure sensor arrangement are disposed laterally next to one another on the upper side of the substrate and are formed by a common layer sequence,
wherein the second pressure sensor arrangement includes a second membrane,
wherein the first membrane and the second membrane are formed by the outer membrane layer,
wherein the substrate and the second membrane enclose a second cavity,
wherein the inner membrane layer is structured such that the inner membrane layer is disposed at least partly in the first cavity and at least partly in the second cavity, and
wherein the outer membrane layer is at least partially mechanically and/or electrically connected to the inner membrane layer such that the first membrane and the second membrane have different stiffnesses.

15. The microelectromechanical pressure sensor according to claim 14, wherein:
the outer membrane layer is connected to the inner membrane layer via first vertical coupling elements disposed in the first cavity and second vertical coupling elements disposed in the second cavity, and
(i) a number and/or a lateral positioning of the first vertical coupling elements with respect to the first membrane and the second vertical coupling elements with respect to the second membrane are different and/or (ii) the geometric dimensions of the first vertical coupling elements and the second vertical coupling elements are different.

16. The microelectromechanical pressure sensor according to claim 14, wherein:
the inner membrane layer includes first portions disposed in the first cavity and second portions disposed in the second cavity, and
(i) a number and/or a lateral positioning of the first portions with respect to the first membrane and the second portions with respect to the second membrane, are different and/or geometric dimensions of the first portions and the second portions are different.

17. The microelectromechanical pressure sensor according to claim 14, wherein:
a first effective electrode is disposed in the first cavity and a second effective electrode is disposed in the second cavity, and
the first effective electrode and the second effective electrode are disposed between the upper side of the substrate and the inner membrane layer, and are substantially the same size.

18. The microelectromechanical pressure sensor according to claim 17, wherein:
at least one reference electrode is disposed in the first cavity as a reference for the first effective electrode between the upper side of the substrate and the inner membrane layer, and
the reference electrode is also provided as a reference for the second effective electrode.

19. The microelectromechanical pressure sensor according to claim 17, wherein:
a first effective electrode is disposed in the first cavity and a second effective electrode is disposed in the second cavity,
the first effective electrode and the second effective electrode are disposed between the upper side of the substrate and the inner membrane layer, and
the second effective electrode is larger than the first effective electrode.

20. The microelectromechanical pressure sensor according to claim 11, wherein:
the layer sequence includes a further inner membrane layer, which is disposed between the upper side of the substrate and the outer membrane layer,
the further inner membrane layer is disposed at least in the first cavity,
the further inner membrane layer is mechanically and/or electrically connected to the inner membrane layer, and/or a first electrically conductive layer, and/or the outer membrane layer.
